(19) United States
(12) Patent Application Publication
(10) Pub. No.: US 2023/0294616 A1
(43) Pub. Date: Sep. 21, 2023

(54) TRIM ELEMENT COMPRISING A FUNCTIONAL LAYER MADE OF CONDUCTIVE PAINT

(71) Applicant: FAURECIA INTERIEUR INDUSTRIE, Nanterre (FR)

(72) Inventors: Adnen NOURI, Cergy (FR); Raquel MACHADO, L'Isle Adam (FR)

(21) Appl. No.: 18/184,526

(22) Filed: Mar. 15, 2023

(30) Foreign Application Priority Data
Mar. 15, 2022 (FR) FR 22 02259

(51) Int. Cl. B60R 13/02; B32B 27/20; B32B 27/32; B32B 33/00; B32B 38/00; G06F 3/041; G06F 3/044

(52) U.S. Cl. CPC B60R 13/02; B32B 27/20; B32B 27/32; B32B 33/00; B32B 38/0004; G06F 3/0414; G06F 3/044; B32B 2307/202; B32B 2307/206; B32B 2260/046; B32B 2260/021; G06F 2203/04105; B60R 2013/0287

(57) ABSTRACT

A vehicle trim element that includes a support layer having an inner face and an outer face, and at least one functional layer of conductive material extending opposite at least part of the inner face and/or the outer face of the support layer. At least part of the functional layer defines at least one pattern that includes at least one conductive area and at least one non-conductive area formed by a through opening in the functional layer. The pattern forming at least part of an electrical circuit being arranged to perform a function of interacting with a passenger of the vehicle on an external surface of the trim element. The conductive material of the functional layer is conductive paint.

### TECHNICAL FIELD

The present invention relates to a vehicle trim element, of the type comprising at least one support layer, comprising an inner face and an outer face, and at least one functional layer of conductive material extending opposite at least part of the inner face and/or the outer face of the support layer, at least part of said functional layer defining at least one pattern comprising at least one conductive area and at least one non-conductive area formed by a through opening in the functional layer, said conductive area being powered by a current source electrically connected to the conductive area, the pattern forming at least part of an electrical circuit arranged to perform a function of interacting with a passenger of the vehicle on an external surface of the trim element.

The invention further relates to a method for producing such a trim element.

### BACKGROUND

The invention applies, for example, to a trim element forming a door panel, a centre console cover, a vehicle dashboard cover or the like.

In such a trim element, it is desirable to integrate some functionality for the vehicle occupants on the outer surface of the trim element. For example, the trim element may include tactile surfaces to enable certain vehicle functions to be controlled, sensing surfaces to detect contact with the outer surface or the like.

The functional elements for carrying out these functions, such as printed circuit boards, are integrated into the trim element, for example under a decorative layer so that they are not visible from the vehicle interior. For example, the circuits are glued to the support layer before the decorative layer is applied to the support layer. However, such a process is time-consuming and can be complicated, especially when several functional surfaces are provided, in which case various functional elements have to be attached at different points of the support layer. In addition, if the functional element(s) is (are) incorrectly positioned on the support layer and/or in relation to the decorative layer, the quality of the trim element is degraded because the functional surfaces do not extend exactly opposite the indications provided on the outer surface of the trim element to indicate their presence and/or their area of activation.

### SUMMARY

One of the aims of the invention is to overcome these disadvantages by providing a trim element comprising one or more functional surfaces that can be produced in a simple, reliable manner.

To this end, the invention relates to a trim element of the aforementioned type, in which the conductive material of the functional layer is a conductive paint.

By making the pattern in a functional layer made of conductive paint, a functional electrical circuit can be defined at a specific location on the support layer in a simple, reliable way. The use of conductive paint provides a layer with good conductivity for the electrical circuit and is less expensive than a layer made from, for example, carbon fibres.

In addition, where multiple functional electrical circuits are provided, they can all be implemented in the functional layer(s), thereby reducing the operations involved in implementing the trim element and simplifying the relative positioning of the different functional electrical circuits on the support layer.

In a particular feature of the invention, the conductive paint comprises graphene and carbon black.

The use of conductive paint containing graphene and carbon black provides particularly good conductivity. The synthesis of graphene can be expensive, but carbon black is very common and inexpensive. By using a mixture of these two materials, a satisfactory conductive paint can be obtained at a reduced price.

The trim element may comprise one or more of the following features, taken alone or in any combination that is technically possible:
the trim element further comprises a protective layer extending over at least a part of the inner side and/or the outer side of the support layer, said protective layer being interposed between said support layer and said functional layer;
an insulation layer extends over said functional layer opposite the support layer, said insulation layer covering said functional layer at least opposite the pattern and filling the through opening in the functional layer;
the insulation layer is a dielectric paint layer;
the trim element comprises a decorative layer extending opposite the outer face of the support layer and forming the outer surface of the trim element;
the support layer is made of a composite material comprising natural fibres in a polypropylene matrix;
the electrical circuit formed by the pattern in the functional layer is at least part of a capacitive circuit so as to form a tactile surface or proximity sensor on at least part of the outer surface of the trim element, a resistive circuit so as to form a pressure sensor or force sensor on at least part of the outer surface of the trim element or a resistive circuit forming a heating element of part of the outer surface of the trim element.

According to another aspect, the invention further relates to a method of making a trim element as described above, comprising the following steps:
providing a support layer;
applying a layer of conductive paint opposite at least part of the inner and/or outer face of the support layer,
cutting the conductive paint layer through its thickness so as to form a pattern comprising at least one conductive area formed by the conductive paint and at least one non-conductive area formed by a through opening in the conductive paint layer so as to form a functional layer 6 defining at least part of an electrical circuit,
electrically connect the conductive area of the functional layer pattern to a power source.

The method may further comprise the following characteristics, taken alone or in any combination that is technically possible:
the method comprises a step of applying a protective layer on at least a part of the inner face and/or the outer face of the support layer before the step of applying the conductive paint layer, said protective layer being interposed between said support layer and said functional layer;
the method comprises a step of applying an insulating layer to said functional layer opposite the support layer after the step of cutting the conductive paint layer, said insulating layer covering said functional layer at least opposite the pattern and filling the through opening in the functional layer;
the carbon material layer is cut by laser etching, chemical etching, milling or mechanical drilling into the carbon material.

### BRIEF DESCRIPTION OF THE DRAWINGS

Other aspects and advantages of the invention will become apparent upon reading the following description, given as an example and referencing the attached drawings, in which:

FIG. 1 is a schematic cross-sectional representation of a portion of a functional element according to one embodiment of the invention, and

FIG. 2 is a schematic cross-sectional representation of different steps in the production of a trim element according to FIG. 1.

### DETAILED DESCRIPTION

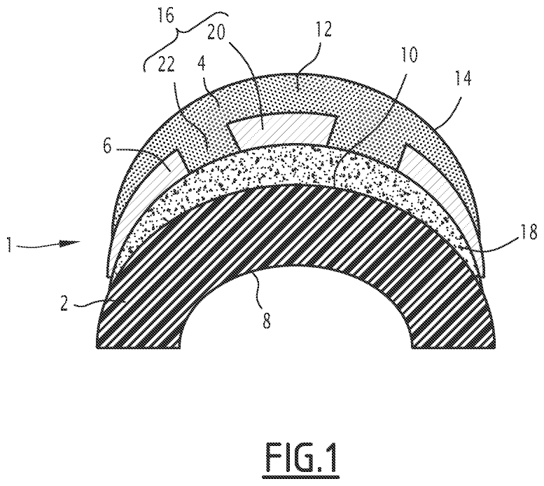

Referring to FIG. 1, a vehicle trim element 1 comprising at least a support layer 2, a decorative layer 4 and a functional layer 6 is described. Such a trim element is intended, for example, to form a door panel, a dashboard or centre console cover or the like.

The support layer 2 is arranged to impart its shape and mechanical characteristics to the trim element 1, in particular its rigidity. The support layer 2 is thus for example made of a substantially rigid material for a door panel, such as a plastic or composite material. In one embodiment, the support layer 2 is made of a composite material comprising natural fibres in a polypropylene matrix, also known as NFPP for “Natural Fibre PolyPropylene”. The natural fibres are, for example, selected from flax, hemp, kenaf and/or wood. The support layer 2 is formed, for example, by thermo-compression in a pressing tool with the desired shape of the support layer 2, which corresponds to the shape of the trim element 1. Thus, the support layer 2 has, for example, a three-dimensional shape with raised areas. By way of example, the support layer 2 may for example comprise an area projecting from the rest of the support layer 2 to form an armrest.

Alternatively, the support layer 2 is made by injecting plastic material, such as polypropylene (PP), polycarbonate acrylonitrile butadiene styrene (PC ABS), or the like, into a mould cavity of the desired shape. In another variant, the support layer 2 is produced by additive manufacturing to the desired shape. The support layer 2 comprises an inner face 8, intended to extend towards the side of the part of the vehicle on which the trim element is to be installed, such as the vehicle door in the case of a door panel, and an outer face 10, opposite the inner face 8, and intended to face the vehicle interior.

The decorative layer 4 extends on the outer face 10 of the support layer 2 over at least a part thereof. The decorative layer 4 is arranged to impart its look and feel to the trim element 1. The decorative layer 4 is thus, for example, made of a flexible or rigid material, with a particular look and/or feel that it is desired to give to the trim element 1. For example, the decorative layer 4 is made of textile material, plastic material, wood material, leather or imitation leather or the like. However, when, as shown in FIG. 1, the decorative layer 4 extends over the functional layer 6 as will be described later, the decorative layer 4 is preferably formed by an insulating layer 12, for example made of dielectric paint. Such an insulation layer 12 will be described in more detail later.

The decorative layer 4 is contoured to the outer face 10 of the support layer 2, i.e. it substantially conforms to the shape of the outer face 10 in the area of the support layer 2 that it covers. In one embodiment, the decorative layer 4 covers the entire support layer 2.

The decorative layer 4 comprises an outer face 14 extending outwards from the trim element 1 and forming the outer surface of the trim element 1, i.e. forming the visible part of the trim element 1 from the vehicle interior. The outer face 14 may include decorative patterns or indications to a user of the presence of a functional area for example, as will be described later. Alternatively or additionally, the decorative layer 4 may be translucent, at least in some areas, to allow light to pass from the outer face 14, allowing these areas to be backlit to inform a user of the presence of a functional area for example.

In one embodiment, the decorative layer 4 is secured directly to the support layer 2. Alternatively, a functional layer 6 is interposed between the support layer 2 and the decorative layer 4, the latter being formed by an insulation layer 12, as shown in FIG. 1.

According to one embodiment, the trim element 1 is devoid of a decorative layer 4 and the outer surface 14 of the trim element is formed by the outer face of the support layer 2 and/or by the functional layer 6 extending over the support layer 2.

The functional layer 6 is a layer made of a carbon material and comprising at least one pattern 16 enabling the functional layer to impart a particular functionality to the trim element 1, as will be described later. The conductive material is a conductive paint containing graphene and carbon black. In other words, the conductive material is a paint based on graphene particles and carbon black, the composition of which is arranged so that the functional layer 6 has a conductivity that allows the pattern 16 to perform the function for which that pattern 16 is intended, as will be described later. In particular, the amount of graphene is adjusted to give the conductive paint the desired conductivity. For example, the conductive paint contains between 0.05 and 50% graphene and between 0.05 and 50% carbon black. More particularly, the conductive paint forming the conductive material is, for example, a commercially available carbon black-based conductive paint to which graphene particles are added in order to improve its conductivity. For example, the composition of the conductive paint is arranged so that the functional layer 6 has a resistivity of less than 30 kOhms/Sq. It should be noted that such a conductive material is particularly economical, especially compared to a layer of carbon material containing carbon fibres for example. Furthermore, such a conductive paint differs from an ink in that it is more liquid and less thick than an ink and is applied by spraying and not by printing, which simplifies its use, as will be described later. In addition, a conductive paint can be applied to a three-dimensional substrate directly, i.e. to an already shaped substrate whose outer side 10 and/or inner side 8 are not flat. The functional layer 6 has, for example, a thickness of between 5 μm and 50 μm.

The functional layer 6 extends over at least part of the inner face 8 or at least part of the outer face 10 of the support layer 2 depending on the function to be performed, as will be described later. According to one embodiment, the functional layer 6 extends over the entire surface of the inner face 8 or the outer face 10 of the support layer.

In one embodiment, the functional layer 6 is applied directly to the support layer 2, i.e. there is no intermediate layer between the support layer 2 and the functional layer 6. However, according to a particularly advantageous design, when the support layer 2 is made of NFPP, a protective layer 18 is interposed between the support layer 2 and the functional layer 6. In other words, the protective layer 18 is applied to the inner side 8 or the outer side 10 of the carrier layer 2 and the functional layer 6 is applied to the protective layer 18 opposite the carrier layer 2, as shown in FIG. 1. The function of the protective layer 18 is to protect the functional layer 6 from moisture and mould that may originate from the support layer 2, especially when the latter contains natural fibres, as mentioned above. In addition, the protective layer 18 is used to block the pores of the carrier layer 2 in order to prevent the functional layer from soaking into the carrier layer 2 during its application and to make the surface to which the functional layer 6 is applied more even. The protective layer 18 is, for example, a paint or coating layer of the polymeric type (e.g. epoxy, acrylic, polyester, etc.). The protective layer is, for example, between 1 and 2000 μm thickness.

The functional layer 6 and, if applicable, the protective layer 18 are conformed to the part of the face of the support layer 2 that they cover, i.e. the functional layer 6 and the protective layer 18 conform to the shape of this part of the face of the support layer 2.

The pattern 16 comprises at least one conductive area 20 formed by the carbon material of the functional layer 6 and at least one non-conductive area 22 formed by a through opening in the functional layer 6. The shapes of the conductive area 20 and the non-conductive area 22 are arranged to form at least part of a functional electrical circuit performing a particular function when the conductive area 20 is supplied with electricity. In other words, the pattern 16 is such that the functional layer 6 defines at least one electrical circuit to perform the desired function when the circuit is powered. Depending on the desired function, several separate conductive areas 20 and non-conductive areas 22 can be provided. Generally, the functional layer 6 comprises at least one through opening defining the pattern 16 to isolate the electrical circuit formed by the pattern 16 from the rest of the functional layer 6.

The functions performed by the electrical circuit(s) are functions of interaction with a vehicle passenger on the outer surface 14 of the trim element. In other words, the functions performed form part of the vehicle's human-machine interface, with vehicle passengers being able to interact with the outer surface 14 of the trim element to activate, control and/or influence the function performed by the electrical circuit formed by the pattern 16. Alternatively or additionally, the electrical circuit formed by the pattern 16 is arranged to heat a portion of the outer surface 14 of the trim element.

Thus, the pattern 16 can be arranged to form an electrical circuit on the outer side 10 of the support layer 2, between this and the decor layer 4, for example a resistive circuit, for example to form a heating element, a force or pressure sensor. The pattern 16 may also be arranged to form a capacitive circuit to form a proximity sensor or touch surface, such as a multi-touch or touch slider surface.

The pattern 16 on one side of the support layer 2 may be arranged to form part of an electrical circuit, another part of which is formed by a pattern on another functional layer 6, also made of conductive paint, for example provided opposite the other side of the support layer 2. Thus, a capacitive circuit may, for example, be formed by a pattern 16 formed in a functional layer 6 facing the outer face 10 of the support layer and by a further pattern, extending opposite the pattern 16, formed in a functional layer 6 facing the inner face 8 of the support layer 2. Alternatively or additionally, the electrical circuit may comprise an active part, formed for example on the side of the outer face 10 of the support layer 2 and arranged to perform the intended function of the circuit, and a supply part, formed for example on the side of the inner face 8 of the support layer 2 and arranged to be connected to a power source for supplying electricity to the circuit. In this case, a connection must be made between the two parts of the circuit, for example through the support layer 2 and, if necessary, through the protective layer(s) 18.

It is understood that a single functional layer 6 or two functional layers on each face may comprise a plurality of patterns 16 in different areas in order to perform different functions on the corresponding different areas of the outer surface 14 of the trim element 1. Thus, for example, a pattern 16 forming a resistive heating circuit is provided on the outer face 10 of the support layer 2 in a first area and a further pattern 16 forming a pressure sensor is provided on the inner face 8 of the support layer 2 in a second area, the pressure sensor enabling, for example, the controlling of the heating surface. Alternatively, several separate patterns forming separate electrical circuits are provided, for example. In some cases, the functions have been described with reference to a particular positioning of the functional layer on one face of the support layer 2. However, it is understood that the same functions could be achieved by placing the functional layer 6 on the other face of the support layer 2.

The or each pattern 16 is supplied with electricity by at least one power source (not shown) electrically connected to the conductive area(s) 20 of the pattern 16, for example connected to terminals formed by a portion of patterns 16, for example in a power supply portion as described above. The power source is, for example, the electrical system of the vehicle in which the trim element is installed. Where a functional layer 6 is provided on each side of the support layer 2 and each comprises at least one separate electrical circuit, each functional layer 6 is supplied with power by one or more power sources.

The functional layer 6 may form an earthing area outside the pattern(s) 16 formed in this functional layer 6. Such an earthing area helps protect the electrical circuit(s) from electrostatic discharges that could damage the electrical circuit(s). To do this, the earthing area is electrically connected to the electrical circuit(s). Alternatively or additionally, the functional layer 6 allows the earthing of one or more electrical circuits of the trim element 1 separate from the circuit(s) formed in the functional layer 6. Thus, the circuit(s) provided on a printed circuit board can be protected from electrostatic discharge by connecting the earthing output of the printed circuit board to the earthing area of the functional layer 6.

As described above, the decorative layer 4 may be formed by an insulation layer 12 arranged to isolate the electrical circuit(s) from the exterior of the trim element and thereby protect users touching the outer surface 14 of the trim element 1. Such an insulating layer 12 is for example formed by a dielectric paint extending over the functional layer 6 opposite the support layer 2 at least opposite the pattern(s) 16 formed therein. According to one embodiment, the insulation layer 12 extends over the entire functional layer 6. In addition, the insulation layer 12 may also extend into the opening(s) forming the non-conductive area(s) 22 of the pattern(s) 16. The insulating layer has, for example, a thickness of between 5 and 50 μm. The insulation layer 12 also makes it possible to protect the support layer 2 and/or the functional layer and to prevent the pattern(s) 16 from being damaged.

The above-described trim element makes it possible to integrate one or more functions on the surface of the trim element in a simple, reliable and economical manner by integrating the electrical circuit(s) for carrying out these functions in one or more functional layers 6, made of a conductive paint based on graphene and carbon black.

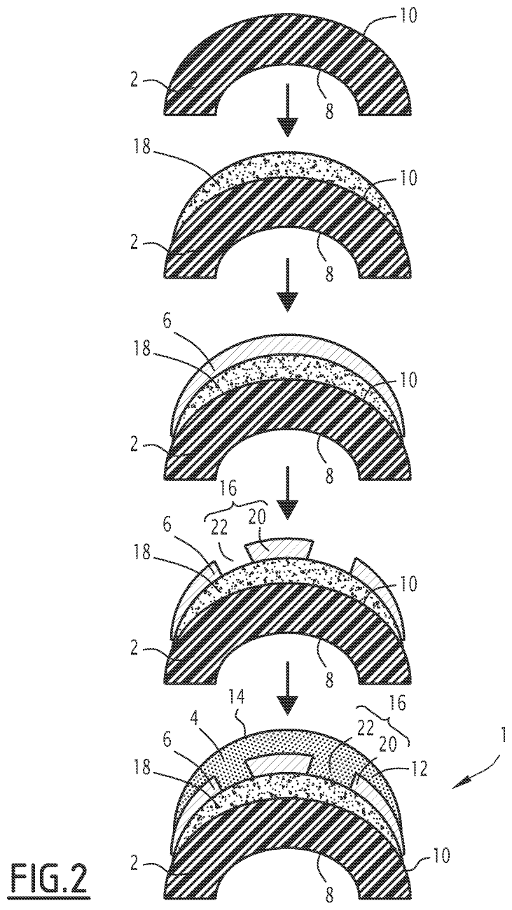

A method of making a trim element according to an embodiment described above will now be described with reference to FIG. 2.

Firstly, a support layer 2 is provided on which a protective layer 18 is applied. The protective layer 18 is deposited on all or part of the inner side 8 and/or outer side 10 of the support layer 2, at least at the place or places where one or more functional layers 6 are provided. The protective layer 18 is applied, for example, by spraying onto the carrier layer 2. As described above, this step is optional and the functional layer 6 can be deposited directly on the support layer 2.

A conductive paint layer 24 is then applied to all or part of the protective layer 18, or if necessary to all or part of the inner and/or outer side of the support layer 2. The conductive paint layer 24 is deposited by spraying, unlike an ink deposited by printing. Such a spraying step is particularly simple and economical to carry out and allows the functional layer to be applied regardless of the shape of the pattern 16 to be made, unlike an ink which is deposited only where the ink is intended, which involves programming the printing appropriately so as not to deposit material where a non-conductive area is intended. When several functional layers 6 are provided, several layers of conductive paint 24 are sprayed on. A functional layer 6 can also be formed by several successive layers of conductive paint.

The pattern(s) 18 are then made in the conductive paint layer 24. For this purpose, at least one through opening is formed in the conductive paint layer to create the non-conductive area 22. The term “through” means that the conductive paint layer 24 is cut through its entire thickness. The shape of the through aperture(s) in the conductive paint layer 24 defines the shape of the pattern 16 and the conductive area(s) 20 thereof. In one embodiment, the conductive paint layer is cut through by means of laser radiation, thereby defining the shape of the pattern 16 very precisely. Alternatively, the conductive paint layer is cut into the conductive paint by etching, milling or mechanical drilling. As described above, several patterns 16 can be provided in the functional layer 6.

If necessary, an insulation layer 12 is then applied to the functional layer 6 at least opposite one or more patterns 16. The insulation layer 12 is applied by spraying and is arranged to penetrate the through opening(s) formed in the functional layer 6.

Alternatively, a decorative layer 4 of another type is applied to the carrier layer 2 and/or the functional layer 6.

The conductive area(s) 20 are then connected to one or more current sources, for example when the trim element 1 is mounted on the vehicle.

A three-dimensional shaping step of the support layer 2 can be provided to give the trim element the desired shape. This step can be carried out before or after the application of the other layers on the support layer 2.

The method is therefore particularly simple and inexpensive to implement. In addition, the pattern(s) 18 can be accurately positioned.

1. A vehicle trim element comprising at least one support layer having an inner face and an outer face, and at least one functional layer made of conductive material extending opposite at least part of the inner face and/or the outer face of the support layer, at least part of said functional layer defining at least one pattern comprising at least one conductive area and at least one non-conductive area formed by a through opening in the functional layer, said conductive area being powered by a current source electrically connected to the conductive area, the pattern forming at least part of an electrical circuit arranged to perform a function of interacting with a vehicle passenger on an external surface of the trim element, wherein the conductive material of the functional layer is a conductive paint.

2. The trim element according to claim 1, wherein the conductive paint comprises graphene and carbon black.

3. The trim element according to claim 1, further comprising a protective layer extending over at least a part of the inner side and/or the outer side of the support layer, said protective layer being interposed between said support layer and said functional layer.

4. The trim element according to claim 1, wherein an insulation layer extends over said functional layer opposite the support layer, said insulation layer covering said functional layer at least opposite the pattern and filling the through opening in the functional layer.

5. The trim element according to claim 4, wherein the insulation layer is a dielectric paint layer.

6. The trim element according to claim 4, wherein the functional layer extends opposite the outer side of the support layer and the insulation layer forms the outer surface of the trim element.

7. The trim element according to claim 1, wherein the support layer is made of a composite material comprising natural fibres in a polypropylene matrix.

8. The trim element according to claim 1, wherein the electrical circuit formed by the pattern in the functional layer is at least part of a capacitive circuit so as to form a tactile surface or a proximity sensor on at least part of the outer surface of the trim element, a resistive circuit so as to form a pressure sensor or a force sensor on at least part of the outer surface of the trim element or a resistive circuit forming a heating element of part of the outer surface of the trim element.

9. A method of manufacturing the trim element according to claim 1, comprising the following steps:
providing a support layer;
applying a layer of conductive paint opposite at least part of the inner face and/or outer face of the support layer,
cutting the conductive paint layer through its thickness so as to form a pattern comprising at least one conductive area formed by the conductive paint and at least one non-conductive area formed by a through opening in the conductive paint layer so as to form a functional layer defining at least part of an electrical circuit, and
electrically connect the conductive area of the pattern of the functional layer to a power source.

10. The method according to claim 9, comprising a step of applying a protective layer on at least a portion of the inner face and/or the outer face of the support layer before the step of applying the conductive paint layer, said protective layer being interposed between said support layer and said functional layer.

11. The method according to claim 9, comprising a step of applying an insulating layer to said functional layer opposite the support layer after the step of cutting the conductive paint layer, said insulating layer covering said functional layer at least opposite the pattern and filling the through opening in the functional layer.
